(19) United States
(12) Patent Application Publication
(10) Pub. No.: US 2008/0217583 A1
(43) Pub. Date: Sep. 11, 2008

(54) Aerosol formulations comprising semiconductor nanocrystal compositions and methods of making the same

(76) Inventors: James Hayes, Homer, NY (US); Luis Sanchez, Troy, NY (US)

Correspondence Address: KENYON & KENYON LLP, 1500 K STREET N.W., SUITE 700, WASHINGTON, DC, 20005, US

(21) Appl. No.: 11/976,017

(22) Filed: Oct. 19, 2007

Related U.S. Application Data
(60) Provisional application No. 60/843,572, filed on Oct. 20, 2006.
(60) Provisional application No. 60/921,643, filed on Apr. 3, 2007.

(51) Int. Cl. C09K 11/06

(52) U.S. Cl. 252/301.35

(57) ABSTRACT

An aerosol formulation including semiconductor nanocrystal compositions. A method for making water based and lacquer based aerosol formulations is also provided. These formulations can be loaded into standard aerosol paint cans and can be sprayed onto a surface. This sprayed paint will fluoresce at the wavelength(s) characteristic of the nanocrystal composition incorporated therein upon illumination with a shorter wavelength source.

### CROSS-REFERENCE TO RELATED APPLICATIONS

The present invention claims priority to U.S. Provisional Application No. 60/843,572, filed Oct. 20, 2006 and U.S. Provisional Application No. 60/921,643, filed Apr. 3, 2007, both of which are incorporated by reference herein.

### FIELD OF THE INVENTION

The present invention relates to aerosol formulations comprising semiconductor nanocrystal compositions and methods of dispersing said semiconductor nanocrystals compositions into a medium to form an aerosol formulation that can be sprayed onto a substrate.

### BACKGROUND

Anti-counterfeiting technology, used to determine the fidelity of a product, continues to be developed and improved. Such technology traditionally seeks to impregnate products or surfaces of product packaging with ink, dye, codes, etching, or other tagging that somehow marks an item as unique and allows it to be distinguished from imitation items. Unfortunately, the profits associated with counterfeit products ensure that new methods are constantly being developed by the underground community to thwart anti-counterfeiting technology. Because of this interplay, new and better anti-counterfeiting technology is always in demand.

### SUMMARY

The present invention provides for aerosol formulations comprising semiconductor nanocrystal compositions capable of emitting light in the infrared wavelength or visible wavelengths that are dispersed in a medium. The medium is designed to be aerosolized and applied to the surface of an object for the purpose of covertly or overtly identifying that object via the semiconductor nanocrystal's emission of light of one or more specific wavelengths upon illumination with a shorter wavelength light source. The semiconductor nanocrystal compositions of the present invention comprise a core semiconductor nanocrystal and optionally an overcoating shell that comprises a semiconductor material that has a band gap greater than that of the core.

In addition to the semiconductor nanocrystal core, the semiconductor nanocrystal compositions may comprise various semiconductor shells and ligands, such as one or more alkyl moieties and usually one metal chelating moiety, thiol, amine, phoshine, or phosphine oxide. The infrared emitting semiconductor nanocrystal compositions are typically prepared in a non-polar solvent such as toluene, chloroform, ether, dimethyl chloride, and other similar solvents. However, through manipulation of the semiconductor nanocrystal compositions they may be placed into inks, paints, dyes, or dispersed onto threads.

The semiconductor nanocrystal compositions of the present invention may be made to produce fine spectral resolution due their narrow full width at half max (typically <100 nm for PbS core semiconductor nanocrystal complexes). Semiconductor nanocrystal compositions may be made in multiple emissions generally from 750 nm to 2300 nm and may be used in certain embodiments of the present invention.

The properties of semiconductor nanocrystal compositions can be exploited to construct a taggant which makes use of the permutations of precise emission wavelengths available to semiconductor nanocrystals. Given the intricate factors which control both emission intensity and wavelength, including size, composition, and excitation frequency; any anti-counterfeiting mechanism comprising semiconductor nanocrystals are difficult to duplicate, without possessing both exact knowledge and technical understanding of each of the above factors. Such knowledge is hard to empirically determine, and could conceivably vary from product to product, making illegal duplication of semiconductor nanocrystal marked products an expensive and time-consuming enterprise worth little even in the unlikely event of success.

### BRIEF DESCRIPTION OF THE DRAWING

FIG. 1 is a schematic illustration of an aerosol can used to dispense an aerosol formulation according to an embodiment of the present invention.

### DETAILED DESCRIPTION

The present invention provides an aerosol formulation comprising an aerosolizable medium and one or more populations of luminescent semiconductor nanocrystal compositions dispersed in the aerosolizable medium. The one or more populations of semiconductor nanocrystal compositions may be a plurality of different populations of semiconductor nanocrystal compositions. By “different” is meant that the semiconductor nanocrystal compositions of one population have properties that are different than the semiconductor nanocrystal compositions of another population. Such properties include, for example, peak emission wavelength, quantum yield, and time domain response. Such parameters and other parameters can be a function of the composition, average diameter, geometry and size distribution of the semiconductor nanocrystal composition.

Semiconductor nanocrystals are crystals of II-VI, III-V, IV-VI, or I-III-VI materials that have a diameter typically between 1 nanometer (nm) and 20 nm. The semiconductor nanocrystals comprise a core semiconductor nanocrystal, which may be spherical nanoscale crystalline materials (although oblate and oblique spheroids can be grown as well as rods and other shapes and may be considered semiconductor nanocrystals) having a diameter of less than the Bohr radius for a given material and are typically II-VI, III-V, or IV-VI semiconductors. Non-limiting examples of semiconductor materials that semiconductor nanocrystal cores can comprise include ZnS, ZnSe, ZnTe, CdS, CdSe, CdTe, HgS, HgSe, HgTe (II-VI materials), PbS, PbSe, PbTe (IV-VI materials), AlN, AlP, AlAs, AlSb, GaN, GaP, GaAs, GaSb, InN, InP, InAs, InSb (III-V materials). In addition to binary semiconductors, semiconductor nanocrystal cores may comprise ternary semiconductor materials or quaternary semiconductor materials and may include I-III-VI materials

A semiconductor nanocrystal core may have an overcoating shell that comprises a semiconductor material having a bulk bandgap greater than that of semiconductor nanocrystal core. In such an embodiment, the shell may act to passivate the outer surface of semiconductor nanocrystal core.

In the strong confinement limit, the physical diameter of the nanocrystal is smaller than the bulk excitation Bohr radius causing quantum confinement effects to predominate. In this regime, the nanocrystal is a O-dimensional system that has both quantized density and energy of electronic states where the actual energy and energy differences between electronic states are a function of both the nanocrystal composition and physical size. Larger nanocrystals have more closely spaced energy states and smaller nanocrystals have the reverse. Because interaction of light and matter is determined by the density and energy of electronic states, many of the optical and electric properties of nanocrystals can be tuned or altered simply by changing the nanocrystal geometry (i.e. physical size).

Single nanocrystals or monodisperse populations of nanocrystals exhibit unique optical properties that are size tunable. Both the onset of absorption and the photoluminescent wavelength emission are a function of nanocrystal size and composition. The nanocrystals will absorb all wavelengths shorter than the absorption onset, however, photoluminescence will always occur at the absorption onset. The bandwidth of the photoluminescent spectra is due to both homogeneous and inhomogeneous broadening mechanisms. Homogeneous mechanisms include temperature dependent Doppler broadening and broadening due to the Heisenberg uncertainty principle, while inhomogeneous broadening is due to the size distribution of the nanocrystals. The narrower the size distribution of the nanocrystals, the narrower the full width at half maximum (FWHM) of the resultant photoluminescent spectra.

Aspects of semiconductor nanocrystals that allow for them to act as an encrypting device are their narrow and specifiable emission peaks, and their excitation wavelength dependent emission intensity. With these traits, several different sizes or material systems (and therefore emission wavelengths) of semiconductor nanocrystal can be combined with several different wavelengths of excitation light in order to create a wide variety of emission spectra. Each of these spectra correspond to one coding combination, which can be made as arbitrarily complicated to duplicate as the encoder wishes.

Specifically, if semiconductor nanocrystals with different emission peaks are mixed together in known quantities, the resulting emission spectrum contains each emission peak present at some measurable intensity. This intensity will be dependent on both the quantity of nanocrystal present and the excitation intensity (or intensities, if several sources are used). By fabricating materials containing predetermined amounts of semiconductor nanocrystals which emit at arbitrary wavelengths, and then establishing their emission spectra at arbitrary excitation wavelengths, one can create a “code” based on the relative intensities of emission peaks. The emission peaks of semiconductor nanocrystal compositions can be tuned to any wavelength between 400 and 2,500 nm n, which is an enormous range requiring very special instrumentation to read correctly. Both the number of semiconductor nanocrystals specimens present and their concentrations can vary arbitrarily, as can the excitation wavelength necessary to excite them to yield the proper emission spectrum. For example, if one combines equal amounts of 1000 nm, 1500 nm, and 2000 nm emitting semiconductor nanocrystals, and excites them at 800 nm; it would yield a different spectral code than equal amounts of 1100 nm, 1600 nm, and 2100 nm emitting semiconductor nanocrystals excited at 900 nm. By changing the number of semiconductor nanocrystals, one can create and record a nearly unlimited variety of different spectral codes which can be easily inserted into plastic sheaths, inks, dyes, fabric, or paper, allowing quantum dot anti-counterfeiting encryption to go anywhere.

Further, the small size of semiconductor nanocrystals makes them relatively easy and inexpensive to fabricate, and their physical complexity makes them an excellent encoding device.

Accordingly, the signature of semiconductor nanocrystals is very precise and counterfeiting would require each counterfeiter to possess the industrial capabilities and competencies of a fully functional semiconductor nanocrystal company laboratory simply in order produce semiconductor nanocrystals of the right quality, bandgap, surface structure, size, and more. Even possessing such a facility would bring a counterfeiter no closer to duplicating the semiconductor nanocrystal codes which can be made arbitrarily complex and which can also be changed frequently at low cost.

For many applications, it is often desirable to have semiconductor nanocrystal compositions that do not emit light in the visible range upon excitation. For example, for security and military applications, it is often desirable to have semiconductor nanocrystal compositions that do not emit light in the visible range upon excitation. Thus, the semiconductor nanocrystal compositions of the present invention could be prepared such that they emit light in the infrared region. The infrared radiation is electromagnetic radiation of a wavelength longer than that of visible light, but shorter than that of microwave radiation. PbS, PbSe, InGaP, CuInGaSe, InSb core and core/shell semiconductor nanocrystals have been used for the preparation of infrared emitting semiconductor nanocrystals. Infrared emitting semiconductor nanocrystals as well as visible emitting nanocrystals may be used for the purpose of the present invention.

One problem in taking advantage of the unique optical properties of semiconductor nanocrystal compositions has been the difficulty in applying them to a desired substrate. The present invention provides for an aerosol formulation comprising semiconductor nanocrystal compositions that may be easily dispersed, comprises a stable shelf life, and allows for the semiconductor nanocrystal compositions to remain bound to surfaces and protected from water. Once the nanocrystal compositions are incorporated into the proper dispersal medium and sprayed onto the surface of an object, the nanocrystal compositions incorporated therein may act as a covert or overt taggant for many applications including security and anti-counterfeiting applications, seals of authenticity etc. A further application of the technology is relating to personnel and equipment identification and covert marking used by police and the military.

In order to place the semiconductor nanocrystal compositions into or onto an article to be detected, the semiconductor nanocrystal compositions are first placed into a dispersal medium, which is capable of being aerosolized, sprayed onto a surface upon which it solidifies via curing or drying, and capable of retaining the luminescent property of the nanocrystal compositions incorporated therein. The aerosolizable medium also acts as a binder that fixes the semiconductor nanocrystals to the surface on which they are sprayed.

In one embodiment of the present invention, the aerosolizable medium in which the semiconductor nanocrystal compositions are dispersed is a lacquer. Non-limiting examples of lacquers include acrylic lacquers such as acrylic resins. Such resins are synthetic polymers, which are typically colorless, transparent, thermoplastic and obtained by the polymerization of derivatives of acrylic acid. Other examples of suitable lacquers include nitrocellulose and uroshiol-based lacquers.

In other embodiments, the aersolizable medium is a water-soluble polymer that inhibits the diffusion of oxygen to the nanocrystal surfaces thereby increasing the stability of the photoluminescent characteristics of the nanocrystals. Exemplary polymers according to this invention are polyvinyl acetate and polyvinyl alcohol, which can be used to form water based aerosol formulations. Other water-soluble polymers are described in co-pending application Ser. No. 11/867,438 entitled “Water Based Colorants Comprising Semiconductor Nanocrystals and Methods of Making and Using the Same,” filed on Oct. 4, 2007 and incorporated by reference herein.

In certain embodiments, the aerosol formulation further comprises an antioxidant. Non-limiting examples of suitable antioxidants are t-butylhydroquinone (TBHQ); N,N′-di-sec-butyl-p-phenylenediamine; 2,6-di-tert-butyl-4-methylphenol; 100% alkylated phenols, principally 2,4-dimethyl-6-tert-butylphenol (97%), 2,4-dimethyl-6-tert-butylphenol (55%), 2,6-di-tert-butyl-4-methyl phenol (15%); propylated and butylated phenols; 2,6-di-tert-butylphenol; Topanal; Ricobond; Anox™; Lowiniox®, Alkylaminophosphate; Vanlube 996E; butylated reaction products of para cresol and dicyclopentadiene (50% dispersion); polymeric hindered phenol antioxidant; polymeric hindered phenol/synergist (DTDTDP thioester) (50% emulsion); polymeric hindered phenol/synergist (DTDTDP thioester) (50% emulsion) (blend 50:50); N,N′-di-beta-naphthyl-p-phenylenediamine (55% dispersion); p-phenylenediamine antioxidant; polymeric hindered phenol/synergist (Tiarco's Antioxidant SN-1 thioester) (55% emulsion) (blend 50:50); non-phenolic antioxidant mixture for all types of latex rubber; 50% anionic aqueous emulsion of Goodyear's Wingstay 29 and Tiarco's Antioxidant SN-1 (made-to-order); butylated reaction product of para-cresol and dicyclopentadiene (50% dispersion); polymeric hindered phenol antioxidant; and polymeric styrenated phenol (52% aqueous antioxidant emulsion).

In certain embodiments, the aerosol formulation further comprises a propellant. Suitable, non-limiting propellants are available from Custom Aerosol, Inc such as ALV-Aerosol, or Fasse Paint. An alternative propellant is pressurized air, which is preferable with a water-based aerosol formulation.

The present invention also provides methods of making an aerosol formulation comprising providing a first mixture comprising an aerosolizable medium dissolved in a solvent. In certain embodiments, the ratio of solvent to aerosolizable medium is 3:1. The first mixture is then mixed. The method further comprises adding a second mixture to the first mixture to form a third mixture. The second mixture comprising semiconductor nanocrystal compositions dispersed in a solvent. The second mixture can be mixed into the first mixture to form a third mixture via any suitable methods such as by using a stir bar, paint shaker, stir stick or other means to agitate the third mixture. In a preferred embodiment, the method is carried out in this sequential order (although additional steps may be performed in between these steps). The third mixture is mixed to achieve the desired viscosity, which is dependent on, for example, the nozzle of the delivery device (i.e. the aerosol can) and the pressure of delivery. In certain embodiments, the final mixture has a viscosity of between about 500-1500 cP as determined less than fifteen seconds in a Zhan cup #2. In certain embodiments, the method further comprises adding an anti-oxidant to any one of the mixtures.

In certain embodiments, the method further comprises adding a propellant to any of the mixtures. Non-limiting examples of propellants include pressurized air and low molecular weight hydrocarbons that have low boiling points such as propane, butane, MEK, and acetone. Typically the propellants are a liquid under pressure in the aerosol can but form a gas when the pressure is released thus pushing the aerosol formulation. Once the aerosol formulation is made, it can be loaded into a standard aerosol can either by hand or machine and it can be sprayed onto a substrate. Non-limiting examples of suitable substrates include metal, glass, plastic, plastic film, textiles, wood, and concrete.

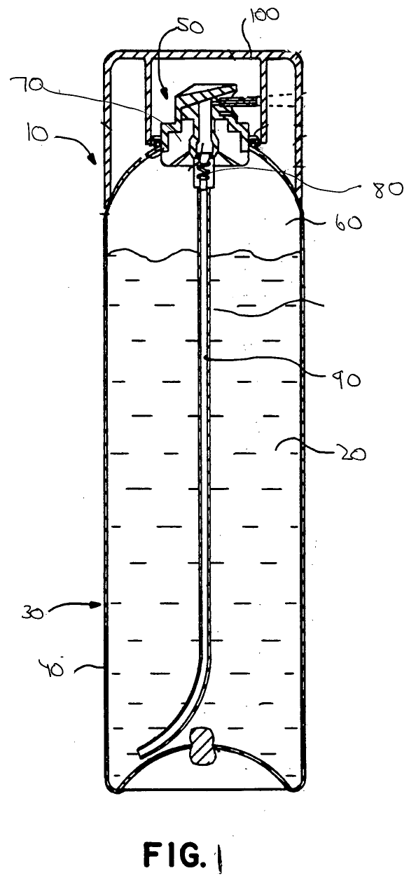

In certain embodiments, the present invention provides a dispenser, such as an aerosol can for dispensing an aerosol formulation according to embodiments of the present invention. Referring to FIG. 1, in certain embodiments, the dispenser 10 comprises a housing 30 and a reservoir 40 within housing 30 that contains an aerosol formulation 20. Dispenser 10 further comprises a valve assembly 50 carried by housing 30 that is adapted to selectively dispense the solution from reservoir 40. Dispenser 10 also includes a high pressure propellant 60 that drives the aerosol formulation through the valve assembly when the valve assembly is activated. Of course, in other embodiments, no propellant is used and the aerosol formulation is driven out via mechanical means. Valve assembly 50 can comprise any suitable valve assembly known in the art. Generally, the valve assembly includes a head piece 70 that is in communication with a spring 80. In a non-activated position, spring 80 biases the valve assembly into a closed position. When head piece 70 is pushed down, valve assembly 50 opens allowing high-pressure propellant 60 to drive aerosol formulation 20 up tube 90, which extends from the bottom of housing 30 to valve assembly 50 at the top of housing 30, through nozzle 100. Dispenser 10 need not include tube 90, however, if the aerosol formulation is contained within a pouch disposed in housing 30 (and the propellant is disposed in housing 30 outside of the pouch), as described in more detail in U.S. Pat. No. 5,059,187.

### EXAMPLES

### Example 1

First, PbS core semiconductor nanocrystals were prepared in toluene using known techniques. Once the nanocrystals were prepared, 0.5 g lacquer was added to 0.05 g of the PbS semiconductor nanocrystals. The desired level of antioxidant was then added to the sample and mixed. Table 1 represents the four formulations of lacquer/semiconductor nanocrystals that were prepared. The control sample contains no antioxidant, Sample 1 contains 5% TBHQ (tertiary butyl hydro quinone), Sample 2 contains 10% TBHQ, and Sample 3 contains 15% TBHQ. Once prepared, each sample was applied by placing several drops onto a slide and then they were allowed to dry. After the sample dried, half of it was covered and then placed into direct sunlight. After the desired amount of sunlight exposure time, the samples were checked for fluorescent activity using NVGs (night vision goggles) and a UV lamp. Each of the prepared samples was tested for fluorescence after 8 hours, 24 hours, and 72 hours. The samples were excited through the use of an ultraviolet lamp and fluorescence was detected using night vision goggles. In Table 1, an “N” indicates that the lacquer comprising the semiconductor nanocrystal complex did not substantially fluoresce upon excitation; “Y” indicates that the lacquer formulation comprising the semiconductor nanocrystal complexes did substantially fluoresce upon excitation.

As indicated in Table 1, the control (0% TBHQ) fluoresced after 8 hours of testing however, after 24 hours of elemental exposure the fluorescence was not substantially detected. By “activity” is meant the ability of the semiconductor nanocrystal composition to remain fluorescent after mixing with lacquer mixture and being applied to a substrate then further exposed to sunlight for some length of time. Sample 1, Sample 2, and Sample 3 each fluoresced upon excitation after 8 hours and Sample 1 and Sample 2 fluoresced upon excitation after 24 hours and 72 hours. The formulations comprising 5% TBHQ and 10% TBHQ (Sample 1 and 2) resulted in an increase of the fluorescent lifetime of the underlying control sample by a factor of three.

In addition to being stable in sunlight, the lacquers prepared above are capable of being easily aerosolized. For example, such lacquer can be placed in a standard hand or machine filling aerosol can and aerosolized with standard aerosol propellants.

TABLE 1

| | | | | Activity | Activity | Activity |
|---|---|---|---|---|---|---|
| | Lacquer/Dot | TBHQ | Activity | fluorescence | fluorescence | fluorescence |
| Sample | solution (%) | (%) | Mixture | After 8 hrs | After 24 hrs | for (72 hr) |
| Control | 100 | 0 | Y | Y | N | N |
| 1 | 95 | 5 | Y | Y | Y | 72+ |
| 2 | 90 | 10 | Y | Y | Y | 72+ |
| 3 | 80 | 20 | Y | Y | N | N |

### Example 2

First semiconductor nanocrystals were prepared. The semiconductor nanocrystal complexes prepared comprised a core of PbS and were in a solution of toluene (13.3 mg/ml Toluene solution) and the nanocrystals, upon excitation, emitted light at 946 nm. A propellant supplied by Custom Aerosol, Inc., product name ALV-Aerosol, was added to the solution. The samples were prepared by adding PbS dots to the lacquer. This was accomplished by adding the desired amount of lacquer to a mixing vessel, adding the semiconductor nanocrystal/toluene solution and mixing the solutions with rapid agitation. The fluorescent activities observed using night vision goggles (NVGs) under normal and UV lighting conditions and the compatibility by eye observation are shown in Table 2. The solutions were observed under normal and UV lighting conditions to determine their fluorescent activity using NVGs. Four lacquers were prepared. Lacquer 7-A was prepared by adding one gram of lacquer to 0.11 g of nanocrystal solution. The mixed solution was loaded into an aerosol can and sprayed onto a sheet of white paper. Once sprayed the mixed solution appeared brown under normal lighting conditions and fluoresced upon excitation. Lacquer solution 7-B was prepared by adding one gram of lacquer to 0.04 grams of nanocrystal solution. The mixed solution was loaded into an aerosol can and sprayed onto a sheet of white paper. Once sprayed the mixed solution appeared brown under normal lighting conditions and fluoresced upon excitation. Lacquer solution 7-C was prepared by adding one gram of lacquer to 0.023 grams of nanocrystal solution. The mixed solution was loaded into an aerosol can and sprayed onto a sheet of white paper. Once sprayed the mixed solution appeared light brown under normal lighting conditions and fluoresced upon excitation. Lacquer solution 7-D was prepared by adding 10 grams of lacquer to 0.023 grams of nanocrystal solution. The mixed solution was loaded into an aerosol can and sprayed onto a sheet of white paper. Once sprayed the mixed solution appeared clear under normal lighting conditions and fluoresced upon excitation. Ultraviolet light was used to excite each example lacquer and night vision goggles were used to detect the fluorescent of the nanocrystal complex. Observation of the sprayed paper under UV illumination shows that emission is active and can hold for several days after spraying.

TABLE 2

| | Lacquer | Nanocrystal | Aerosol Solution | Aerosol Solution |
|---|---|---|---|---|
| Sample | (g) | Solution (g) | Color | Fluorescence |
| 7A | 1.0 | 0.11 | Brownish | Yes |
| 7B | 1.0 | 0.04 | Brownish | Yes |
| 7C | 1.0 | 0.023 | Light brownish | Yes |
| 7D | 10.0 | 0.017 | Clear | Yes |

### Example 3

A water based aerosol formulation was made by mixing the same PbS nanocrystals as in the above examples with a polymer, namely polyvinyl acetate (PVA). This mixture was then added to a water based formulation and agitated. The end solution was 25% PVA, 49% water, 21% toluene, and 5% PbS quantum dots. The propellant used was simply pressurized air. This was added to spray cans and produced a similar formulation to that mentioned above, however it is a water based formulation which could be used in different applications.

Although the above described examples are for the addition of one type of semiconductor nanocrystal composition it is appreciated that more than one wavelength or type of semiconductor nanocrystal composition may be added to any lacquer as described. For example, it may be desirable to have more than one emission wavelength, in such a case two or more different types of semiconductor nanocrystal cores emitting at two or more different wavelengths may be added to the lacquer as described above or two or more different wavelengths of the same type of semiconductor nanocrystal core may be added to the lacquer.

The foregoing description and examples have been set forth merely to illustrate the invention and are not intended as being limiting. Each of the disclosed aspects and embodiments of the present invention may be considered individually or in combination with other aspects, embodiments, and variations of the invention. Further, while certain features and embodiments of the present invention may be shown in only certain figures, such features can be incorporated into other embodiments shown in other figures while remaining within the scope of the present invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention. Further, it is appreciated that although a number of problems and deficiencies may be identified above with respect to the prior emulsions containing semiconductor nanocrystals, each embodiment of the present invention may not solve each problem identified in the art.

Additionally, to the extent a problem identified in the art or an advantage of the present invention is not cured, solved or lessened by the claimed invention, the solution to such problems or the advantage identified above should not be read into the claimed invention. Furthermore, all references cited herein are incorporated by reference in their entirety.

We claim:

1. An aerosol formulation comprising:
an aerosolizable medium; and
one or more populations of luminescent semiconductor nanocrystal compositions dispersed in the aerosolizable medium.

2. The aerosol formulation of claim 1, wherein the aerosolizable medium is a lacquer.

3. The aerosol formulation of claim 2, wherein the lacquer is an acrylic resin.

4. The aerosol formulation of claim 1, wherein the aerosolizable medium is a water soluble polymer.

5. The aerosol formulation of claim 4, wherein the water soluble polymer is a polyvinyl acetate or a polyvinyl alcohol.

6. The aerosol formulation of claim 1, further comprising an antioxidant.

7. The aerosol formulation of claim 1, further comprising a propellant.

8. A method of making the aerosol formulation of claim 1 comprising:
(a) providing a first mixture comprising an aerosolizable medium dissolved in a solvent;
(b) mixing the first mixture;
(c) adding a second mixture to the first mixture to form a third mixture, the second mixture comprising semiconductor nanocrystal compositions dispersed in a solvent; and
(d) mixing the third mixture.

9. The method of claim 8, further comprising adding an anti-oxidant to any of the mixtures.

10. The method of claim 8, further comprising adding a propellant to any of the mixtures.

11. The method of claim 8, further comprising loading the aerosol formulation into a standard aerosol can.

12. A method of using the aerosol formulation of claim 1, comprising spraying the aerosol formulation onto a substrate

13. An aerosol can comprising the aerosol formulation of claim 1.
